(19) United States
(12) Patent Application Publication
(10) Pub. No.: US 2025/0384490 A1
(43) Pub. Date: Dec. 18, 2025

(54) Wave-Induced Collapse of Quantum and Probabilistic Systems via Observer Interference

(71) Applicant: LARRY LIM KHENG CHEONG, SINGAPORE (SG)

(72) Inventor: LARRY LIM KHENG CHEONG, SINGAPORE (SG)

(21) Appl. No.: 19/318,749

(22) Filed: Sep. 4, 2025

Related U.S. Application Data
(63) Continuation of application No. 19/172,805, filed on Apr. 8, 2025.

(51) Int. Cl. G06Q 40/04; G06N 10/20

(52) U.S. Cl. CPC G06Q 40/0421; G06N 10/20

(57) ABSTRACT

A system and method for trading and risk management are disclosed. The invention introduces a Q-Score framework derived from the Total Wave Modified Schrödinger Equation (TWMSE), using five quantum physics indicators: price curvature, phase interference, amplitude-amplitude interaction, amplitude-charge interaction, and volatility-price correlation. A genetic algorithm optimizer adapts indicator weights by asset and regime, generating buy, sell, or neutral signals. Collapse-based logic enables abstain states, reducing false positives. Integrated risk protocols include adaptive sizing, pyramiding, and turnover controls. Tests on equities and FX in August 2025 confirm robustness, supporting institutional use in adaptive, explainable platforms. This Continuation-in-Part extends prior wave-collapse inventions into the domain of financial markets, providing a physics-inspired, adaptive, and transparent system that bridges theoretical innovation with practical trading execution across diverse asset classes.

### 1. CROSS-REFERENCE TO RELATED APPLICATIONS

This application is a Continuation-in-Part of U.S. application Ser. No. 19/172,805, filed Apr. 8, 2025, entitled Wave-Induced Collapse of Quantum and Probabilistic Systems via Observer Interference, the entire contents of which are incorporated herein by reference. The present invention extends the principles disclosed in that application, which describe wave-interference collapse dynamics as a general framework, into the specific field of trading and risk management systems via quantum physics collapse dynamics

### 2. FIELD OF THE INVENTION

The invention relates generally to trading and risk management systems, and more particularly to systems employing quantum physics collapse equations, interference-based indicators, and genetic algorithms to generate adaptive buy, sell, and neutral trading signals across multiple asset classes, including equities, foreign exchange (FX), commodities, cryptocurrencies, and fixed income instruments.

### 3. BACKGROUND OF THE INVENTION

Financial markets are characterized by complex, nonlinear dynamics that shift rapidly between regimes of trending, mean-reverting, volatile, and illiquid behavior.
1. Conventional statistical models (e.g., regression, ARIMA, factor models) assume linearity and stationarity. These assumptions rarely hold in real-world markets, leading to fragile predictions that collapse under stress.
2. FX markets present an additional challenge, as they lack centralized volume data. Conventional price-volume indicators cannot be applied uniformly.
3. Equity and commodity models break down during volatility shocks or sudden regime changes, producing unreliable signals.
4. Machine learning models such as deep neural networks can fit historical data but are prone to overfitting, lack interpretability, and often fail catastrophically when market conditions shift.

As a result, traders and institutions are forced to choose between simple, brittle models or complex black-box systems that lack transparency. Neither class of solutions provides the adaptability, reliability, or interpretability demanded by institutional risk managers and regulators.

Accordingly, there is a clear need for a physics-inspired forecasting framework that can dynamically adapt to regime changes, self-calibrate its decision logic, provide transparent explanations of trading signals, and operate across multiple asset classes even when data structures differ.

### 4. SUMMARY OF THE INVENTION

1. The present invention addresses the above deficiencies by introducing a Q-Score collapse-based signal generation framework, which integrates:
2. Quantum-inspired indicators derived from wave interference and collapse dynamics, capturing nonlinear relationships in price, volume, and volatility.
3. Genetic algorithm (GA) optimization, allowing the system to evolve indicator weights dynamically for each asset and regime.
4. Decision logic that produces buy, sell, or abstain signals, with abstain states reducing false positives when conditions are incoherent.
5. Risk protocols including adaptive position sizing, pyramiding, turnover penalties, and neutral states to reduce drawdowns.
6. Portfolio-level optimization, enabling diversification and correlation-aware allocation across multiple instruments.
7. Explainability features, allowing decomposition of signals into weighted indicator contributions for transparency and auditability.
8. This invention therefore provides an adaptive, explainable, and cross-asset trading system that improves performance while reducing risk relative to existing approaches.

### 4A. Advantages of the Invention

The invention offers several distinct advantages over the prior art:
1. Cross-Asset Applicability: Functions across equities, FX, commodities, cryptocurrencies, and fixed income, even where volume data are missing, by substituting proxies such as implied volatility or futures open interest.
2. Physics-Inspired Indicators: Captures nonlinear dynamics overlooked by linear regressions or factor models by modeling collapse-like interactions.
3. Evolutionary Adaptation: The genetic algorithm continually recalibrates, ensuring robustness under regime shifts.
4. Abstain Signals: Unlike binary buy/sell models, this system can abstain, thereby reducing false positives and unnecessary trades.
5. Built-In Risk Management: Provides pyramiding, adaptive sizing, and turnover controls directly within the collapse-based trading system.
6. Explainability: Trading signals can be decomposed to show the contribution of each indicator, enhancing trust for institutional users.
7. Superior Performance: In August 2025 tests, the system demonstrated strong Sharpe ratios and hit rates across both equities and FX.

### 5. DETAILED DESCRIPTION OF THE INVENTION

### 5.1 Indicators and Formulas

The Q-Score framework employs five quantum-inspired indicators:

### 1. Price Curvature (Ψ″ₚ):

Cₜ=log(Pₜ)−2 log(Pₜ₋₁)+log(Pₜ₋₂)

This measures the acceleration of log prices, analogous to wave curvature. Unlike simple momentum, curvature highlights turning points where acceleration changes direction, signaling potential reversals or breakouts.

### 2. Phase Interference Indicator (PII):

PIIₜ=cos(φₚ−φᵥ)

where φₚ and φᵥ are instantaneous phases of price and volume (or proxy). This indicator detects whether price and volume are moving in constructive alignment (cos˜+1) or destructive opposition (cos˜−1), a direct analogy to wave interference in physics.

### 3. Amplitude-Amplitude Interaction (AAI):

AAIₜ=|Mₜ·|Vₜ|

where Mₜ=Δlog Pₜ represents momentum. This captures reinforcement between price momentum and trading activity, distinguishing meaningful moves from random noise.

### 4. Amplitude-Charge Interaction (ACI):

ACIₜ=|Mₜ|·log(Σᵢ₋₁^{k}Vₜ₋ᵢ)

This incorporates cumulative “charge” of market activity (volume history), allowing the system to distinguish between isolated spikes and momentum backed by sustained activity.

### 5. Volatility-Price Correlation (VCI):

VCIₜ=Corr(M_{t-w:t}, σ_{t-w:t})

where Mₜ=Δlog (Pₜ)
where σ is realized or implied volatility. VCI quantifies how strongly price momentum aligns with volatility, a key indicator of stress and structural breaks.

Together, these indicators form a wave-inspired state representation of the market.

### 5.2 Genetic Algoritham (GA)

The GA is used to evolve optimal weights [w1, w2, w3, w4, w5] for the indicators.
Chromosome: [w1, w2, w3, w4, w5]
Fitness Function:

F=(S/√(1+D))−λ·T

where S=Sharpe ratio, D=maximum drawdown, T=turnover, and λ penalizes excessive trading.
Evolutionary Operators: tournament selection, crossover, and Gaussian mutation.
Walk-Forward Training: the GA is re-run on rolling windows, ensuring continual adaptation to new market regimes.

This approach ensures that each asset and regime receives a dynamically evolved weighting scheme, avoiding static assumptions.

### 5.3 Decision Logic

The system computes the composite Q-Score:
Composite Q-Score:

Qₜ=Σᵢ₌₁⁵ wᵢ I_{i,t}
If Qₜ>θ: Buy.
If Qₜ<−θ: Sell.
If Qₜ≤θ: Neutral/Abstain.

The threshold θ is optimized per asset and regime, allowing the system to explicitly identify non-tradable states.

### 5.4 Applications

Validated: August 2025 tests on U.S. equities and G10 FX pairs.
Applicable: The framework can be extended to crypto (using tick-level proxies), commodities (using futures open interest), and bonds (using volatility-based proxies).
Portfolio Layer: A higher-order GA may allocate capital across assets to minimize correlation clustering and systemic risk.

### 5.5. Risk Management

Adaptive Sizing: position size scales with collapse signal confidence.
Pyramiding: allows gradual accumulation into favorable trades while enforcing caps.
Turnover Penalties: discourage excessive trading, reducing noise-driven churn.
Abstain Mechanism: reduces false positives and improves stability in incoherent markets.

### 5.6 Explainability

Each forecast can be decomposed into weighted indicator contributions.
Importance analysis (e.g., SHAP values) quantifies which features drove a signal.
Integration into Bloomberg API and OMS/EMS ensures institutional usability.
   6. Exam ples and Reso August 2025)

### Example 1

### Equities

In August 2025, the Q-Score was tested on 33 U.S. equities.
Median Sharpe Ratio: 7.33.
Median Hit Rate: 72%.
Notable results: AAPL (Sharpe 8.1, Hit 75%), TSLA (Sharpe 6.4, Hit 70%), GE (Sharpe 4.9, Hit 68%).

These results demonstrate robustness across diverse equity profiles.

### Example 2

### G10 FX

The system was tested on 8 G10 FX pairs using implied volatility as a volume proxy.
Median Sharpe Ratio: 3.68.
7 of 8 pairs achieved hit rates above 70%.
GBP/USD produced negative Sharpe and was correctly abstained, avoiding false positives.

### Example 3

### Failure Detection

The abstain logic improved Sharpe by +1.1 and reduced drawdowns by 27% across tested equities and FX in August 2025.

### Applicability

Although August 2025 validations were limited to equities and FX, the same framework is directly applicable to other asset classes (crypto, commodities, bonds, portfolios) by substituting appropriate data proxies.

1. A system for trading and risk management via collapse dynamics, comprising:
(a) a plurality of quantum-inspired indicators derived from wave-interference principles, including price curvature, phase interference, amplitude-amplitude interaction, amplitude-charge interaction, and volatility-price correlation;
(b) a genetic algorithm optimizer configured to assign dynamic weights to said indicators on a per-asset basis through iterative selection, crossover, and mutation; and
(c) a decision engine configured to generate buy, sell, or neutral trading signals based on the weighted composite indicator output, wherein the system adapts to asset-specific regimes and identifies non-tradable states.

2. A method for generating trading signals via collapse dynamics, comprising the steps of:
(a) computing quantum-inspired indicators from market data;
(b) applying a genetic algorithm to evolve indicator weightings;
(c) generating a composite Q-Score; and
(d) outputting a buy, sell, or neutral trading decision based on said Q-Score.

3. A non-transitory computer-readable medium storing instructions which, when executed by one or more processors, cause the system to perform the method of claim 2.

4. The system of claim 1, wherein the decision engine is applied to equities and produces out-of-sample signals with Sharpe ratios exceeding 3.0 for select assets.

5. The system of claim 1, wherein the decision engine is applied to foreign exchange markets, and wherein implied volatility is used as a proxy for trading volume to compute the amplitude-charge interaction and volatility-price correlation indicators.

6. The system of claim 1, wherein the decision engine is applied to cryptocurrencies using tick-level activity or futures open interest as proxies for trading volume.

7. The system of claim 1, wherein the genetic algorithm includes a walk-forward training protocol that recalibrates indicator weights on rolling time windows to adapt to market regime changes.

8. The system of claim 1, further comprising a portfolio-level genetic optimizer configured to allocate capital across multiple instruments by minimizing correlation clustering and drawdowns.

9. The method of claim 2, wherein the indicators are normalized to z-scores within training windows to control for distributional drift.

10. The method of claim 2, wherein the genetic algorithm is configured to optimize a Pareto front of Sharpe ratio, maximum drawdown, and turnover.

11. The system of claim 1, wherein the decision engine outputs a neutral or abstain signal when collapse coherence falls below a defined threshold.

12. The system of claim 1, wherein the system integrates broker quotes and execution models to account for slippage and transaction costs.

13. The system of claim 1, wherein pyramiding is employed in equity applications, capped by instrument-level risk budgets.

14. The method of claim 2, wherein regime detection includes tagging carry, trend, mean-reverting, and volatility-crush states.

15. The system of claim 1, wherein ensemble genetic algorithms with different seeds are combined to reduce estimator variance.

16. The system of claim 1, wherein the volatility-price correlation indicator is derived from realized volatility instead of implied volatility.

17. The method of claim 2, wherein adaptive position sizing scales by collapse signal confidence and recent drawdown.

18. The system of claim 1, wherein turnover controls are included to penalize excessive trading during optimization.

19. The system of claim 1, wherein the portfolio-level optimizer includes cross-asset hedging to minimize systemic risk.

20. The computer-readable medium of claim 3, wherein explainability is provided by computing indicator importance scores for the quantum-inspired indicators to attribute contribution to each trading decision.
